(19) United States
(12) Patent Application Publication
(10) Pub. No.: US 2007/0273207 A1
(43) Pub. Date: Nov. 29, 2007

(54) Operational Control for a Vehicle

(75) Inventors: Manfred Dorn, Stuttgart (DE); Hans-Dieter Futschik, Gechingen (DE); Christian Knop, Stuttgart (DE); Joern Petersen, Stuttgart (DE); Gerhard Seidel, Denkendorf (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/589,232

(22) PCT Filed: Feb. 11, 2005
(86) PCT No.: PCT/EP05/01373

§ 371 Date: May 18, 2007

(51) Int. Cl. B60L 1/00; G09G 5/00

(52) U.S. Cl. 307/10.1; 345/156; 297/217.3; 296/24.34

(57) ABSTRACT

An operating device for a vehicle has operating elements for operating different electrical equipment such as, for example, a navigation device, an audio system, a heating and/or air conditioning system and/or a telephone. In order to permit the driver of a vehicle to operate such units as conveniently as possible, and to avert his attention as little as possible during driving operation, it is proposed to design the operating device such that the operating device has a support body that prescribes a fixed position of the operating hand and has operating elements in the form of a control wheel and keys surrounding the control wheel. The keys are arranged in an operating plane such that they enclose an obtuse angle with the support surface formed by the support body.

### BACKGROUND AND SUMMARY OF THE INVENTION

This invention relates to an operating device for a vehicle.

Electrical equipment that requires a sophisticated operating device is increasingly to be found in modern motor vehicles. Thus, German document DE 199 44 324 A1 exhibits a multifunctional operating device that has a combination of a rotary switch and a number of push button switches. The different switches can be used to control diverse items of electronic equipment in the vehicle such as, for example, a telephone, a radio, a CD player, a navigation device and the like. However, operating such a combination composed of various switches is not simple and requires a heightened attentiveness of the driver.

German document DE 197 32 287 A1 exhibits a multifunctional operating device that uses a bidirectionally rotatable and axially movable switching device. The selection of a menu from a number of menus that are shown on a display is performed with the aid of this switching device.

German document DE 101 05 177 C2 discloses an operating device for a vehicle computer system. This operating device imitates a computer mouse and has a number of control wheels as well as a number of keys as operating elements. The operating elements are arranged in a common body and are situated relatively closely next to one another. Consequently, the operation of this device requires a more concentrated attentiveness of the driver and can distract him from what is happening during driving.

German document DE 100 12 753 A1 discloses an operating device having a three-dimensional operating member in the form of a motor vehicle. Here, as well, a multiplicity of operating elements in the form of key surfaces or switching elements are situated in the outer contour of the operating member.

It is an object of the present invention to provide an operating device for motor vehicles that permits a multiplicity of switching functions to be executed and various items of electronic equipment to be operated, and which can be operated in a simple way and thus distracts the driver as little as possible. In particular, the aim is for the operating device to be of ergonomically advantageous design and to enable simple and convenient operation both during driving operation and when standing still.

This object is achieved according to the invention by an operating device having the features claimed.

The operating device has operating elements in the form of keys and a rotatable control wheel. In addition, a support body is provided that has a support surface for laying on a hand. The keys and the control wheel are arranged in a front section of the operating device, and the support body is arranged in a rear section for the purpose of conveniently laying on the hand. The keys are arranged in an operating plane that encloses an obtuse angle with the support surface. This means that the support surface is inclined toward the keys or that the keys are inclined toward the support surface. By laying the hand on the support surface of the support body, the operator experiences a relaxed posture of the hand and fingers. In addition, the support surface offers a reference point such that even during driving operation a defined position of the operating hand is ensured in relation to the operating elements under the influence of acceleration forces or centrifugal forces. The arrangement of the keys in an operating plane that encloses an obtuse angle with the support surface, that is to say an angle in a range between 100 degrees and 175 degrees, has the advantage furthermore that the keys can be reached by the operating hand in an ergonomically advantageous position, and it is therefore also possible to operate blindly. It is likewise possible to operate during driving operation, and this does not distract the driver disproportionately.

In particular, it is provided that the control wheel has an axis of rotation that is inclined approximately at right angles, preferably in a range from 70° to 110°, to the support surface. This enables a particularly convenient operation of the control wheel, since when the hand is laid on to the support surface the fingers of the operating hand automatically grip the contour of the control wheel with a natural posture. As a result of this arrangement of the axis of rotation, the plane of rotation of the control wheel is inclined in the direction of the operating plane or the keys. This has the advantage that the fingers of an operating hand need cover only a shortest possible path when operating the keys and operating the control wheel in an alternating manner.

In one design it is provided that one or more further operating elements in the form of keys and/or rotary regulators are additionally arranged to the left and/or right next to the control wheel. This increases the number of possible switching functions and, moreover, prevents the need to actuate too many switching functions or menu functions with the aid of a single operating element. As a result, a user operates very varied items of equipment in a way that is convenient and rational, being susceptible, in particular, to being conducted intuitively. It is advantageous that these further operating elements are arranged in an operating plane running parallel to the support surface, since this permits an ergonomically advantageous operation.

It is provided in an advantageous design that the support surface of the support body has a curvature that is ergonomically adapted to the shape of a hand surface. Consequently, the support surface fits the hand snugly and forms for the hand a defined fixed point for supporting and positioning the hand. Thus, the operating hand can operate the operating device reliably without being hindered by any possible acceleration forces. In addition the support surface can be upholstered and covered with an upholstery material, preferably leather, imitation leather or a fabric.

In order to enable the control wheel to be operated in a fashion that is convenient and largely free from error, it can be provided that the control wheel has a contoured surface. To this end, the surface can have a peripheral surface or end surface that is fluted or provided with a honeycomb structure. It can additionally be provided that the peripheral surface or end surface of the control wheel has an antislip coating or an inlay made from an antislip material, preferably a plastic or rubber. In order further to improve the operability of the control wheel, it can be provided that the peripheral surface or end surface of the control wheel has two mutually inclined surfaces that touch one another at a peripheral line. This peripheral line then constitutes the line of largest diameter of the control wheel. It has emerged that it is advantageous that the bottom surface has a greater extent by comparison with the top surface, a particularly advantageous support thereby being formed for the fingers. Owing to the two mutually inclined surfaces, the operator obtains a tactile feedback relating to the bearing of the fingers on the peripheral surface of the control wheel. Because the bottom surface has a greater extent than the top surface and, moreover, is inclined in a fashion pointing toward the axis of rotation, when the fingers bear against the peripheral surface on the bottom surface an additional support space is produced for the finger tips of the hand operating the control wheel. The result for the operator is a particularly convenient haptic of high quality appearance for operating the control wheel.

It can additionally be provided that the control wheel has a latching device that supplies a tactile feedback for the operator during rotation of the control wheel. This means that while rotating the control wheel the operator enjoys a quasicontinuous operation that is subdivided into a number of small latching switching positions that can be felt discretely. Consequently, for example, a number of points can be selected from a display menu in a simple way and, above all, also reliably during blind operation.

It can be provided in one design that in the case of the operating elements one key or a number of keys has or have a shape and/or surface that can be distinguished uniquely haptically. Thus, for example, a key that has a triangular shape and/or surface contour can be provided for actuating a hazard warning system. In this way, a specific key, preferably the key for the hazard warning system, can be selected and actuated solely by feeling or making out by touch. The operability is thereby improved such that the driver's attentiveness is not unnecessarily distracted from what is happening during driving.

It can be provided in one design that the support body has a foldable support surface, there being located inside the support body a key pad that is rendered accessible by folding the support surface open. This key pad located inside the support body is mechanically protected and/or covered in the normal position, that is to say the folded closed position, of the support surface, and is freely accessible to an operator after being folded over. This key pad provides the possibility of inputting large quantities of alpha numeric data in a convenient way such as is known in the case of a commercially available PC or a telephone. The operator can thus select whether he prefers to input via the control wheel or the keys. Thus, the key pad inside the support body can be used to input large quantities of data such as, for example, telephone numbers or other data.

It is provided, in particular, that the operating device is arranged in a center console of a passenger car. This provides that the operating device is freely accessible from the driver's side and from the front passenger side. Moreover, the operating device can also be arranged in an arm rest of a driver's seat, for example a driver's seat, a front passenger seat or a front seat.

The operating device according to the invention can also be used to control and/or operate electronic equipment which requires complex operation and exhibits a correspondingly complex operating surface. Thus, for example, this operating device can be used to control the operation of a telephone and/or an audio system and/or an air conditioning system and/or a navigation device. In addition, yet further switching functions can also be actuated via the operating device. Thus, for example, this operating device can be used to control a hazard warning system or a lighting system as well as a seat heating system or interior illumination.

Further advantages and refinements of the invention follow from the figures and the associated description thereof.

### BRIEF DESCRIPTION OF THE DRAWINGS

FIG. 1 shows a side view of the operating device.

FIG. 2 shows a plan view of the cut away support body with control wheel.

FIG. 3 shows a sectional view of the control wheel.

FIG. 4 shows a plan view of the operating device with the support body folded open.

FIG. 5 shows a perspective view of the operating device in a motor vehicle.

### DETAILED DESCRIPTION OF THE INVENTION

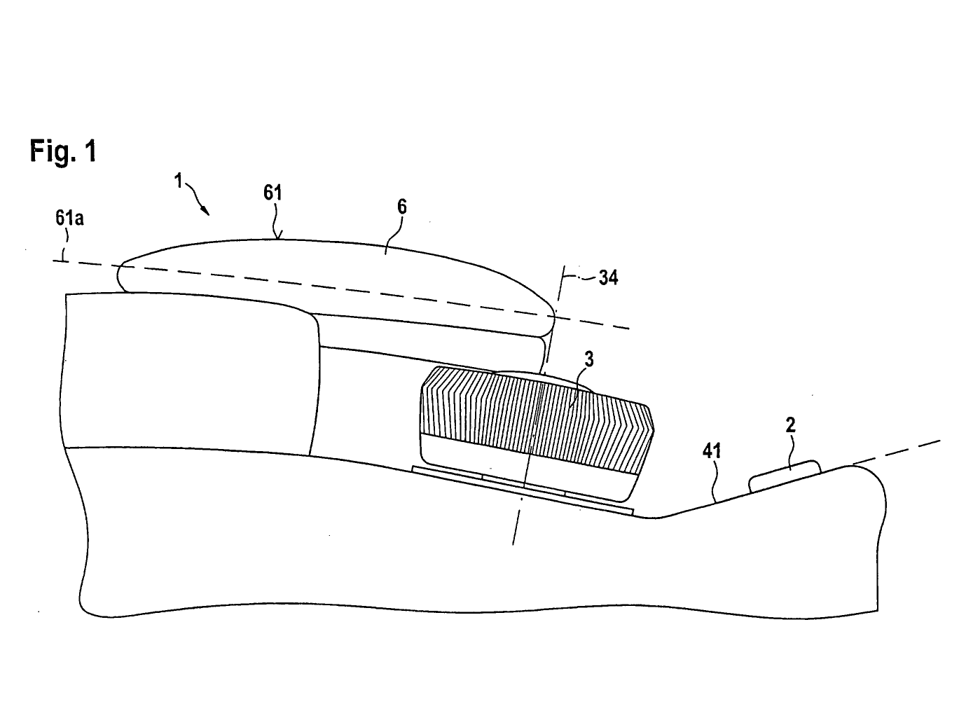

FIG. 1 shows the operating device 1 in a side view such as can be arranged, for example, on a center console of a vehicle. The operating device 1 has a support body 6 that has an ergonomically advantageously shaped support surface 61 for laying on a hand. In addition, the operating device 1 further has operating elements in the form of a control wheel 3 and keys 2. The control wheel 3 is mounted such that it can rotate about an axis of rotation 34 aligned vertically in the vehicle, and is arranged at least partially below the support body 6.

Seen in the driving direction, the keys 2 are arranged in front of the control wheel at such a distance from the support body 6 that a hand laid on the support body 6 reaches both the control wheel 3 and the keys 2 conveniently and without changing position. For this purpose, the operating device 1 is divided into a front section and a rear section. The operating elements, that is to say the control wheel 3 and the keys 2, are arranged in the front section, and the support body 6 with the support surface 61 is arranged in the rear section. The support body 6 or the support surface 61 lies in a plane 61a that runs in an inclined fashion toward the keys 2. The keys 2 for their part lie in an operating plane 41 that encloses an obtuse angle with the plane 61a of the support surface 61.

The control wheel 3 is arranged or mounted such that its approximately vertically aligned axis of rotation 34 approximately forms a right angle with the plane 61a of the support surface 61. This arrangement of the individual operating elements of the operating device 1 enables a particularly convenient and ergonomically advantageous operation of the operating device 1. In particular, there is a reduction in the parts that have to be covered by the fingers of an operating hand lying on the support body 6 when they are intended to operate the different individual operating elements. Thus, for example, it is possible to operate all the operating elements, that is to say the control wheel 3 and the keys 2, without the need for the hand lying on the support body 6 to change its position. In addition, this arrangement prevents the control wheel from being actuated inadvertently upon actuation of the keys, or vice versa.

The support surface 61 has a convex curvature that is adapted to the shape of a hand. The surface of the support 61 is upholstered and provided with a leather covering. This results in pleasant haptics for the operating hand resting on the support body.

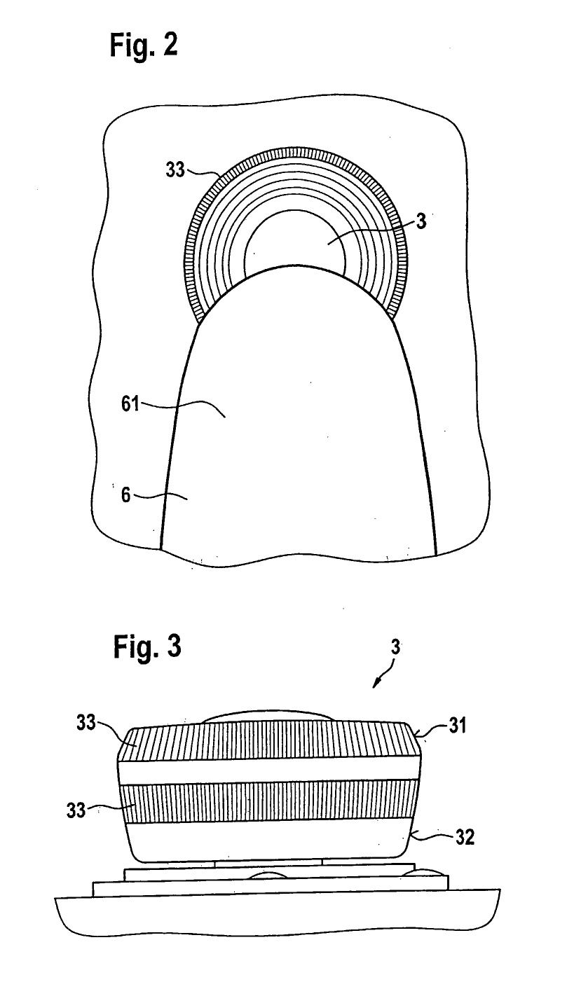

FIG. 2 illustrates as a plan view the support body 6 with the control wheel 3 lying there below. The plan view clearly shows the rounded shape of the support surface 61 that fits snugly into the surface of the operating hand. The control wheel 3 has on its end surface a contour 33 that is provided on the peripheral surface in the form of fluting 33 and thus improves the operability of the control wheel 3. The control wheel 3 is shown in FIG. 3 as a sectional illustration. The control wheel 3 has at its peripheral surface a top surface 31 and a bottom surface 32. The surfaces 31 and 32 are arranged inclined to one another such that the control wheel 3 has its greatest diameter at the line of contact of the surfaces 31 and 32. By comparison with the top surface 31, the bottom surface 32 has a greater extent. The surface 32 is inclined such that its bottom end points toward the center of the control wheel 3, that is to say the control wheel 3 tapers continuously downward from the position of its greatest circumference. This taper gives rise to a holding space for the fingertips of the hand operating the control wheel. In addition, a contour 33 in the form of fluting that further improves the haptics of the control wheel is incorporated into each of the surfaces 31, 32.

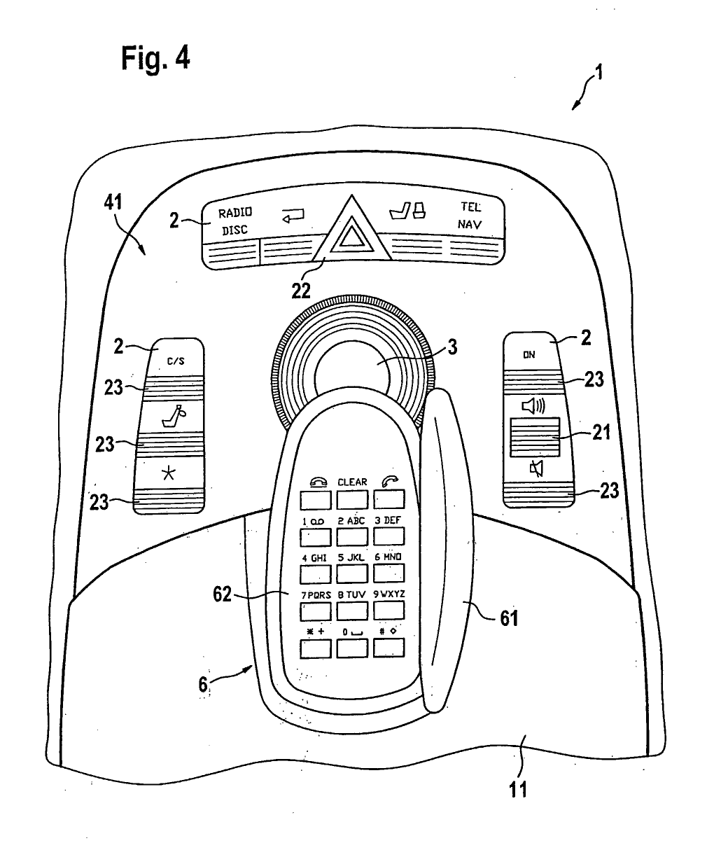

The operating device 1 is illustrated in plan view in FIG. 4. The operating device is arranged on a center console 13, and the support surface 61 of the operating body 6 is folded open. Held inside the operating body 6 is a key pad 62 that is freely accessible with the support surface 61 folded open. The key pad 62 can be used for the convenient input of relatively large quantities of alphanumeric data, for example telephone numbers or address data. Thus, for example, a cell phone or a navigation unit can be operated conveniently and in a way to which the user is accustomed. With the support surface 61 folded closed, the key pad 62 held in the support body 6 is completely covered and mechanically protected.

In addition, with the support surface 61 folded closed the support body 6 forms a body of inherently closed appearance that because of its rounded shapes exhibits a visually pleasing exterior and an ergonomically advantageous form. In a forward extension of the support body 6, the control wheel 3 is supported such that it reaches partially below the support body 6. Arranged in addition to the left and right next to the control wheel 3 are further keys 2 that are used to operate diverse electronic equipment. Likewise, there is arranged in front of the control wheel 3 a further key strip 2 with the aid of which it is possible to operate additional electronic equipment. For example, the keys can be used to operate an audio system, in particular a car radio or a CD player, as well as a cell phone or a navigation device. However, it is also possible to operate functions such as seat adjustment or seat ventilation, or the functioning of the ventilation and/or heating or air conditioning system via the keys.

Arranged in addition on the right next to the control wheel 3 illustrated in FIG. 4 is a volume control 21 that is designed as a rotary regulator, and with the aid of which it is possible to set the volume of the telephone or of the audio system in a convenient and accustomed way.

Arranged in a forward straight line extension of the support body 6 is a key 22 that is provided for actuating a hazard warning system. This key 22 has a raised contour of a triangle and can therefore be distinguished unambiguously from the other keys 2 by its outer contour. A hazard warning system can thereby also be switched on and off in blind operation.

The individual keys 2 respectively have an area of the switching surface that triggers a switching function upon being actuated, and a web 23 that is adjacent thereto and separates different areas of the switching surface from one another. This web or these webs 23 has or have a raised contour and profile fluting. They thus provide an additional orientation aid and support for a finger that is searching for the switching surface in order to actuate a specific switching function. Via these webs 23, an operator obtains a tactile feedback and can select and actuate the switching surface he desires solely through feeling. This means that the attentiveness of the driver is distracted from what is happening during driving as little as possible by the operation of the operating device.

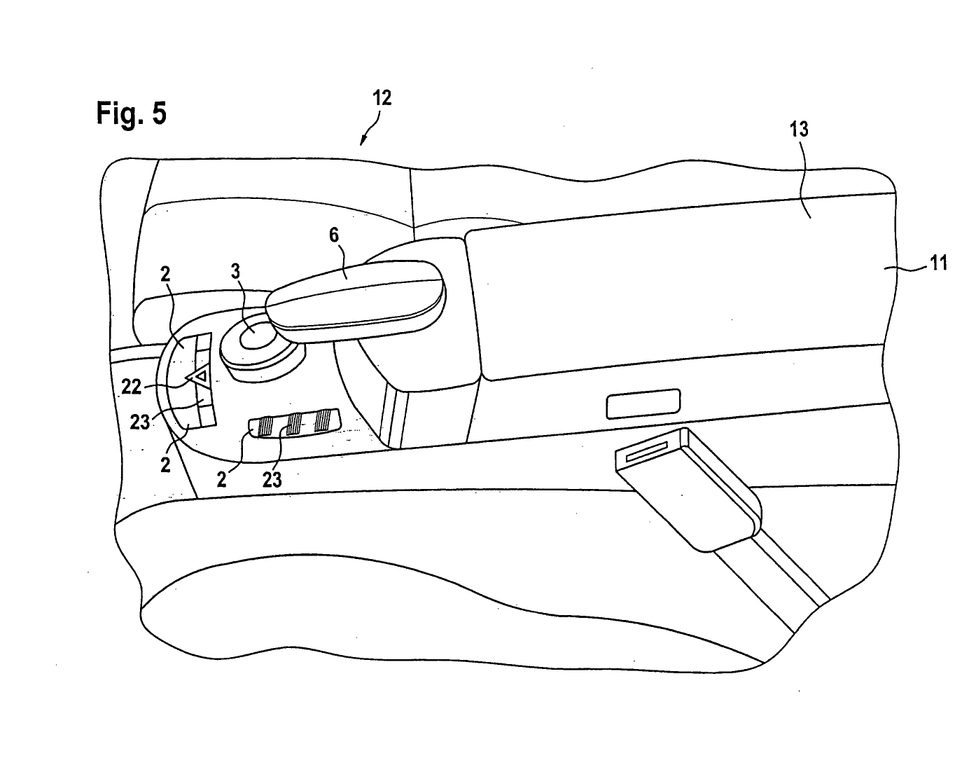

The operating device 1 is illustrated in FIG. 5 on a center console 11 in a motor vehicle. The operating device 1 is arranged in the middle between a driver's seat and a front passenger seat 12, and forms the front termination of the arm rest 13. The driver or the front passenger can lay his arm comfortably on to the arm rest 13 in the region of the center console 11, and in so doing support the hand surface on the support body 6. The support body 6 in this case forms a fixed point for the hand surface and ensures that the hand assumes a defined position relative to the operating elements even under the influence of centrifugal forces or acceleration forces.

The control wheel 3, which is arranged in large part below the support body 6, is supported such that it can rotate bidfrectionally, and is surrounded by further operating elements, the keys 2, in the immediate area to hand for the near zone. Thus, it is possible to execute all switching functions with the ball of the thumb at rest. The keys respectively have a switching surface with the aid of which a desired switching function can be triggered. They are bounded by a web 23 at their end directed toward the support body. The web 23 has a raised contour, in particular a camber, that serves as a support for a finger. This enables a particularly relaxed operation of a specific key.

The key 22 projects as a raised triangle from the operating strip 2 arranged in front of the control wheel 3, and preferably serves for activating a hazard warning system. Owing to its raised shape, the key can be comfortably felt and defines the midline of the operating device 1 together with the control wheel 3. As a result, the key 22 provides the user with an additional aid to orientation and supports him in automatically, preferably intuitively operating the operating device 1.

It is envisaged to use the operating device 1 in passenger cars. In this case, it can be arranged in the front region or else in the front region on individual seats or between two seats. The operating device can be operated comfortably both by left handed and by right handed people. The operating device 1 can, however, also be used in other vehicles, for example aircraft or rail bound vehicles, in order to operate complex electronic equipment.

1-10. (canceled)

11. An operating device for a vehicle comprising:
keys,
a rotatable control wheel, the keys and the control wheel being arranged in a front section, and
a support body with a support surface for laying on a hand arranged in a rear section,
wherein the axis of rotation of the control wheel is arranged at right angles to the support surface,
wherein the keys are arranged in an operating plane that encloses an obtuse angle with the support surface, and
wherein the peripheral surface of the control wheel has a top surface and a bottom surface that are inclined to one another such that the control wheel has its greatest diameter at the line of contact of the surfaces.

12. The operating device as claimed in claim 11, wherein, arranged to at least one of the left and the right, next to the control wheel, is at least one further key and at least one rotary regulator in an operating surface running parallel to the support surface.

13. The operating device as claimed in claim 11, wherein the support surface has a curvature adapted ergonomically to a hand surface.

14. The operating device as claimed in claim 11, wherein a large part of the control wheel is arranged below the support surface.

15. The operating device as claimed in claim 11, wherein the control wheel has a contoured peripheral surface.

16. The operating device as claimed in claim 11, wherein the bottom surface has a greater extent than the top surface, and forms an ergonomically advantageous bearing surface for fingers.

17. The operating device as claimed in claim 11, wherein the support surface is of foldable design and, in a normal position, protects, covers, or protects and covers a key pad arranged inside the support body.

18. The operating device as claimed in claim 11, wherein a key or a number of keys has or have a haptically uniquely distinguishable shape, surface, or shape and surface such that a key or a number of keys can be selected or distinguished solely by feeling.

19. A center console of a vehicle comprising an operating device as claimed in claim 11.

20. A vehicle seat having an arm rest with an operating device as claimed in claim 11.

21. The operating device as claimed in claim 11, wherein the keys and the rotatable control wheel are for operating at least one of vehicle functions, an audio system, a telephone, and a navigation device.

22. The operating device as claimed in claim 15, wherein the peripheral surface is a fluted peripheral surface.

23. The operating device as claimed in claim 12, wherein the support surface has a curvature adapted ergonomically to a hand surface.

24. The operating device as claimed in claim 12, wherein a large part of the control wheel is arranged below the support surface.

25. The operating device as claimed in claim 13, wherein a large part of the control wheel is arranged below the support surface.

26. The operating device as claimed in claim 12, wherein the control wheel has a contoured peripheral surface.

27. The operating device as claimed in claim 13, wherein the control wheel has a contoured peripheral surface.

28. The operating device as claimed in claim 14, wherein the control wheel has a contoured peripheral surface.

29. The operating device as claimed in claim 12, wherein the bottom surface has a greater extent than the top surface, and forms an ergonomically advantageous bearing surface for fingers.
